(19) United States
(12) Patent Application Publication
(10) Pub. No.: US 2012/0022821 A1
(43) Pub. Date: Jan. 26, 2012

(54) INTEGRATED CIRCUIT THAT TRANSFERS MISSION MODE SIGNAL IN DEBUG MODE

(76) Inventors: Paul Dembiczak, Washougal, WA (US); Mark John Reed, Camas, WA (US); Wei Seng Chew, Singapore (SG)

(21) Appl. No.: 12/842,743

(22) Filed: Jul. 23, 2010

(51) Int. Cl. G06F 19/00

(52) U.S. Cl. 702/120

(57) ABSTRACT

A system including an integrated circuit configured to transfer a mission mode signal between a mission mode circuit on the integrated circuit and a first input/output pin on the integrated circuit in mission mode and to transfer a development mode signal between a development mode circuit on the integrated circuit and the first input/output pin in debug mode. The integrated circuit is configured to transfer the mission mode signal between the mission mode circuit and a second input/output pin on the integrated circuit in debug mode.

### BACKGROUND

Often, an application specific integrated circuit (ASIC) includes circuits that perform functions in normal operation, referred to as mission mode circuits, and circuits that are used for development and debug of the ASIC hardware, firmware, and software, referred to as development mode circuits. Some mission mode signals and some development mode signals, such as task-level debug signals, are low bandwidth or low frequency signals, and some mission mode signals and some development mode signals, such as those associated with real-time trace, are high-bandwidth or high-frequency signals that require careful control of loads, routing, and impedances. Low bandwidth signals are in the 100 kilo-Hertz (kHz) or less frequency range and high bandwidth signals are in the 1 mega-Hertz (MHz) or greater frequency range. Typically, input/output (I/O) pins are dedicated to mission mode circuits and other input/output pins are dedicated to development mode circuits.

ASIC pins dedicated to development mode circuits have become a significant contributor to overall ASIC cost and direct material cost. For example, a printer ASIC may have 10 to 18 pins dedicated to real-time trace, 5 to 12 pins dedicated to the central processing unit (CPU) debugger port, and 4 or more pins dedicated to the universal asynchronous receiver transmitters (UARTs) that are used for status and task-level debug. These development and debug I/O pins have no function in the final shipping product, but the product direct material cost continues to be burdened with them in production.

ASIC designers and manufacturers continuously look for ways to reduce product cost. As silicon geometries continue to shrink, integrated circuit package costs become a larger piece of the component cost. Also, as silicon geometries continue to shrink there is more of a tendency for integrated circuit silicon to become I/O bound, i.e., the amount that the silicon can be shrunk is limited by the number of I/O circuits and pins. However, development mode signals cannot simply be removed from the product without losing debug capabilities, which may be required to solve bugs or yield issues that surface later.

For these and other reasons there is a need for the present invention.

### BRIEF DESCRIPTION OF THE DRAWINGS

FIG. 1 is a diagram illustrating one embodiment of a system.

FIG. 2 is a diagram illustrating one embodiment of a system that includes a switching circuit and an off-chip mission mode circuit(s).

FIG. 3 is a diagram illustrating one embodiment of a system that includes a switching circuit that provides one or more mission mode signals to an ASIC.

FIG. 4 is a diagram illustrating one embodiment of a system that includes a switching circuit that receives a mission mode signal from an ASIC.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

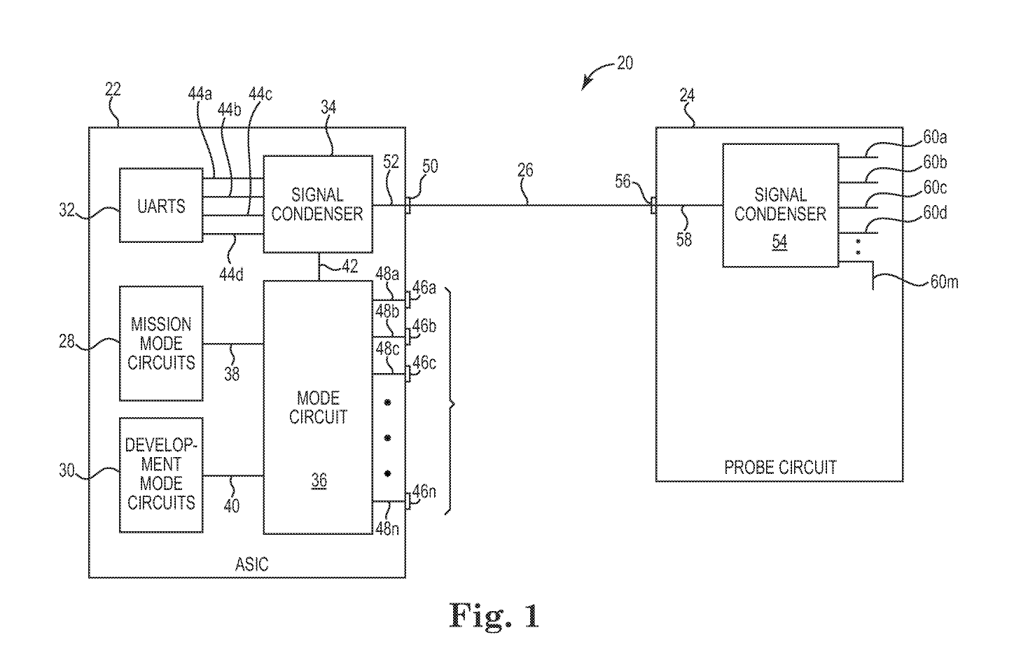

FIG. 1 is a diagram illustrating one embodiment of a system 20 that uses at least one I/O pin for a mission mode signal in mission mode and the same I/O pin for a development mode signal in debug mode, where at least one other I/O pin is used for the mission mode signal in debug mode.

System 20 includes an ASIC 22 and a probe circuit 24 communicatively coupled to the ASIC 22 via communications path 26. In one embodiment, ASIC 22 is situated on a main circuit board that is substantially the same as the main circuit board used in the mission mode application. In one embodiment, probe circuit 24 is situated on a development and debug circuit board. In one embodiment, probe circuit 24 is a field programmable gate array (FPGA) situated on a development and debug circuit board.

ASIC 22 includes mission mode circuits 28, development mode circuits 30, UARTs 32, an ASIC signal condenser 34, and a mode circuit 36. UARTs 32 in ASIC 22 are development mode circuits. In other embodiments, ASIC 22 does not include the UARTs 32.

Mission mode circuits 28 are electrically coupled to mode circuit 36 via first mission mode signal paths 38, and development mode circuits 30 are electrically coupled to mode circuit 36 via development mode signal paths 40. Mode circuit 36 is electrically coupled to ASIC signal condenser 34 via second mission mode signal paths 42, and UARTs 32 are electrically coupled to ASIC signal condenser 34 via UART paths 44a-44d. Mode circuit 36 is electrically coupled to first I/O pins 46a-46n via I/O paths 48a-48n and ASIC signal condenser 34 is electrically coupled to second I/O pin 50 via condenser I/O path 52. In one embodiment, ASIC 22 is built for use in a printer application. In one embodiment, ASIC 22 is built for use in an all-in-one printer application. In one embodiment, ASIC 22 is built for use in an ink jet printer application. In one embodiment, ASIC 22 is built for use in a laser printer application.

Probe circuit 24 includes a probe circuit signal condenser 54 that is electrically coupled to probe circuit I/O pin 56 via condenser I/O path 58. ASIC signal condenser 34 is communicatively coupled to probe circuit signal condenser 54 via second I/O pin 50, communications path 26, and probe circuit I/O pin 56.

Mission mode circuits 28 include low bandwidth mission mode circuits, such as general purpose I/O's, digital encoders, and pulse width modulators, and high bandwidth mission mode circuits that perform other ASIC functions. In one embodiment, the low bandwidth mission mode circuits operate in the 100 kHz or less frequency range and the high bandwidth mission mode circuits operate in the 1 MHz or greater frequency range.

Development mode circuits 30 include high bandwidth development mode circuits, such as real-time firmware trace circuits, and high or medium bandwidth development mode circuits, such as CPU debugging ports and/or JTAG circuits. UARTs 32 include multiple low bandwidth development mode circuits, such as task-level debug circuits. In one embodiment, the low bandwidth development mode circuits operate in the 100 kHz or less frequency range and the high bandwidth development mode circuits operate in the 1 MHz or greater frequency range.

ASIC signal condenser 34 and probe circuit signal condenser 54 communicate via communications path 26 to transfer signals between ASIC 22 and probe circuit 24.

In one embodiment, ASIC signal condenser 34 and probe circuit signal condenser 54 receive and/or transmit (transfer) signals serially via second I/O pin 50, communications path 26, and probe circuit I/O pin 56. ASIC signal condenser 34 receives signals via second mission mode signal paths 42 and/or UART paths 44a-44d and serializes the signals to provide a serial data stream to probe circuit signal condenser 54 via communications path 26. Probe circuit signal condenser 54 receives the serial data stream and de-serializes the serial data stream to provide output signals on probe circuit signal paths 60a-60m. Also, probe circuit signal condenser 54 receives signals via probe circuit signal paths 60a-60d and serializes the signals to provide a serial data stream to ASIC signal condenser 34 via communications path 26. ASIC signal condenser 34 receives the serial data stream and de-serializes the serial data stream to provide output signals on second mission mode signal paths 42 and/or UART paths 44a-44d.

Mode circuit 36 transfers signals between mission mode circuits 28 and first I/O pins 46a-46n in mission mode and between development mode circuits 30 and first I/O pins 46a-46n in debug mode. In addition, in debug mode, mode circuit 36 transfers signals between mission mode circuits 28 and ASIC signal condenser 34 via first mission mode signal paths 38 and second mission mode signal paths 42. In one embodiment, mode circuit 36 receives a mode input signal at one of the first I/O pins 46a-46n, which puts mode circuit 36 into either mission mode or debug mode based on the value of the mode input signal. In other embodiments, ASIC 22 and mode circuit 36 are put into either mission mode or debug mode via multiple mode pin configurations or a programmable register.

In mission mode, mode circuit 36 transfers high bandwidth and low bandwidth mission mode signals between mission mode circuits 28 and first I/O pins 46a-46n. Mode circuit 36 dedicates first I/O pins 46a-46n to mission mode signals in mission mode. The development mode signals are not used or are inactive.

In debug mode, mode circuit 36 transfers at least one, i.e., one or more, of the mission mode signals between the mission mode circuits 28 and ASIC signal condenser 34. ASIC signal condenser 34 transfers these mission mode signals between mode circuit 36 and second I/O pin 50 and communicates with probe circuit signal condenser 54 via second I/O pin 50, communications path 26, and probe circuit I/O pin 56. Probe circuit signal condenser 54 receives and/or provides the UART signals and mission mode signals. Transferring mission mode signals between the mission mode circuits 28 and second I/O pin 50, frees up the first I/O pins 46a-46n that correspond to the mission mode signals transferred to ASIC signal condenser 34. Also, in debug mode, mode circuit 36 transfers development mode signals between development mode circuits 30 and the first I/O pins 46a-46n that were freed up. Thus, the same first I/O pins 46a-46n used for mission mode signals in mission mode are used for development mode signals in debug mode. In one embodiment, mode circuit 36 transfers one or more low bandwidth mission mode signals between the mission mode circuits 28 and ASIC signal condenser 34, and mode circuit 36 transfers one or more high bandwidth development mode signals between development mode circuits 30 and the first I/O pins 46a-46n that were freed up.

In one embodiment, in debug mode, ASIC signal condenser 34 serializes/de-serializes UART signals and the mission mode signals transferred between the mission mode circuits 28 and ASIC signal condenser 34. ASIC signal condenser 34 serially communicates with probe circuit signal condenser 54 via second I/O pin 50 and probe circuit signal condenser 54 serializes/de-serializes the UART signals and mission mode signals.

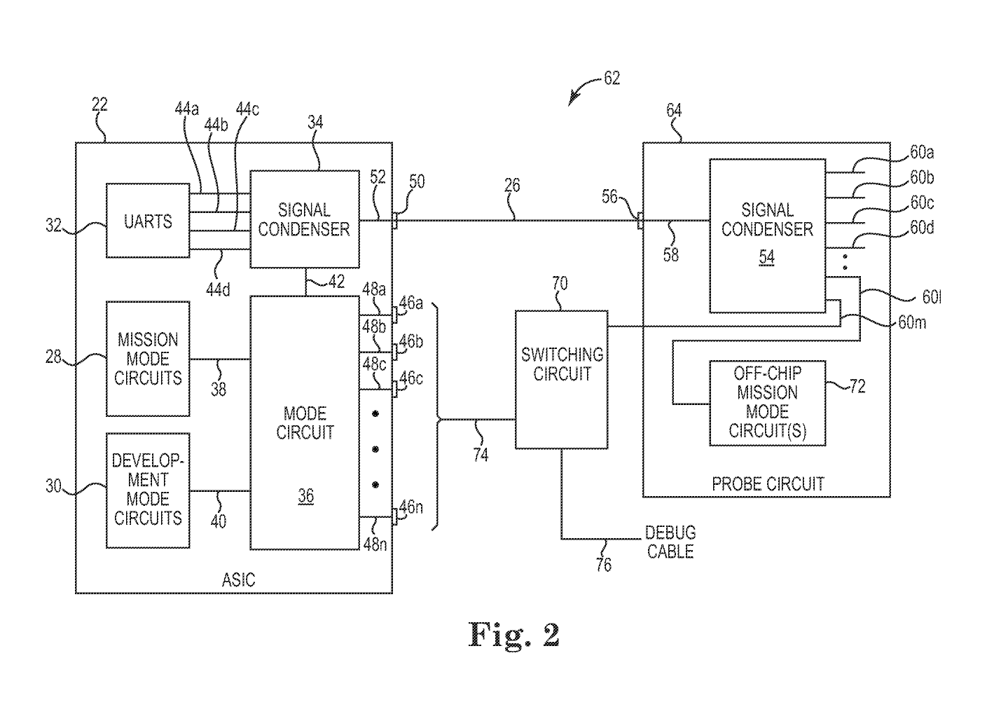

FIG. 2 is a diagram illustrating one embodiment of a system 62 that includes a switching circuit 70 and a probe circuit 64 that includes an off-chip mission mode circuit or circuits 72. System 62 is similar to system 20 of FIG. 1 and probe circuit 64 is similar to probe circuit 24 (shown in FIG. 1).

Switching circuit 70 is electrically coupled to one or more of the first I/O pins 46a-46n via switching paths 74 and to probe circuit signal condenser 54 via one or more of the probe circuit signal paths 60a-60m (shown as probe circuit signal path 60m in FIG. 2). Off-chip mission mode circuit(s) 72 are electrically coupled to probe circuit signal condenser 54 via one or more of the probe circuit signal paths 60a-60m (shown as probe circuit signal path 60l in FIG. 2).

In mission mode, switching circuit 70 transfers one or more mission mode signals between one or more corresponding first I/O pins 46a-46n and mission mode drivers and/or receivers in switching circuit 70 via switching paths 74. The mission mode drivers and/or receivers are not part of ASIC 22 and are only logically included in switching circuit 70. In one embodiment, the mission mode drivers and/or receivers are part of the main circuit board that includes ASIC 22. In one embodiment, the mission mode drivers and/or receivers are part of another circuit board, and not the main circuit board that includes ASIC 22.

In debug mode, switching circuit 70 transfers one or more development mode signals between one or more corresponding first I/O pins 46a-46n and debug cable 76. Switching circuit 70 also transfers one or more mission mode signals between the mission mode drivers and/or receivers logically situated in switching circuit 70 and probe circuit signal condenser 54 via probe circuit signal paths 60a-60m, such as probe circuit signal path 60m. Off-chip mission mode circuits 72, such as a blinking light emitting diode (LED) that indicates the application is running or other mission mode circuits including low bandwidth mission mode circuits, transfer one or more mission mode signals between the off-chip mission mode circuits and probe circuit signal condenser 54 via probe circuit signal paths 60a-60m, such as probe circuit signal path 60l. Thus, in debug mode, one or more of the first I/O pins 46a-46n are used to transfer development mode signals, such as high bandwidth development mode signals to debug cable 76 via switching circuit 70. Also, in debug mode, second I/O pin 50 is used to transfer one or more mission mode signals between ASIC signal condenser 34 and probe circuit signal condenser 54, which transfers the one or more mission mode signals to mission mode circuits in switching circuit 70 and/or off-chip mission mode circuit(s) 72 on probe circuit 64.

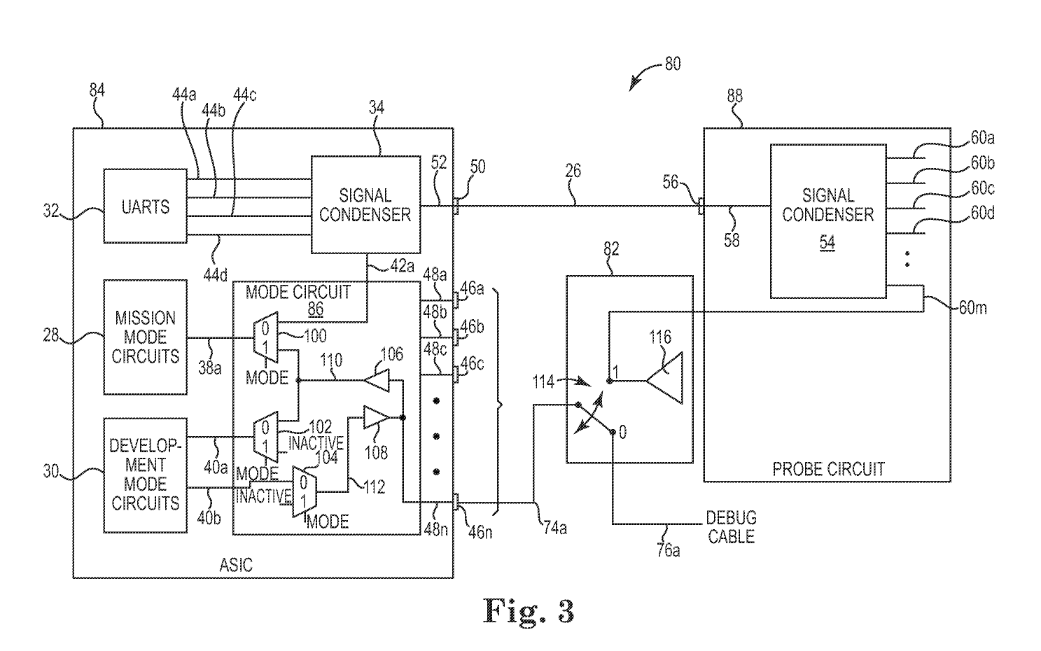

FIG. 3 is a diagram illustrating one embodiment of a system 80 that includes switching circuit 82 that provides one or more mission mode signals to ASIC 84 and mode circuit 86 that transfers development mode signals to and from debug cable 76. UARTs 32 in ASIC 84 are development mode circuits. In other embodiments, ASIC 84 does not include the UARTs 32.

System 80 is similar to system 20 of FIG. 1. Also, ASIC 84 is similar to ASIC 22 (shown in FIG. 1) and probe circuit 88 is similar to probe circuit 24 (shown in FIG. 1).

Mode circuit 86 includes a first multiplexer 100, a second multiplexer 102, a third multiplexer 104, an input circuit 106, and an output circuit 108. The input of input circuit 106 and the output of output circuit 108 are electrically coupled together and to first I/O pin 46n via I/O path 48n. The output of input circuit 106 is electrically coupled to the 1 input of first multiplexer 100 and the 0 input of second multiplexer 102 via internal path 110. The 0 input of first multiplexer 100 is electrically coupled to ASIC signal condenser 34 via second mission mode signal path 42a and the output of first multiplexer 100 is electrically coupled to at least one of the mission mode circuits 28 via first mission mode signal path 38a. The 1 input of second multiplexer 102 is inactive and the output of second multiplexer 102 is electrically coupled to at least one of the development mode circuits 30 via development mode signal path 40a. The 0 input of third multiplexer 104 is electrically coupled to at least one of the development mode circuits 30 via development mode signal path 40b and the 1 input of third multiplexer 104 is inactive. The output of third multiplexer 104 is electrically coupled to the input of output circuit 108 via another internal path 112.

Switching circuit 82 includes a switch 114 and a mission mode driver circuit 116 that provides mission mode signals. One side of switch 114 is electrically coupled to the input of input circuit 106 and the output of output circuit 108 via switching path 74a, first I/O pin 46n, and I/O path 48n. The 0 side of switch 114 is electrically coupled to debug cable line 76a and the 1 side of switch 114 is electrically coupled to the output of mission mode driver circuit 116 and to probe circuit signal condenser 54 via probe circuit signal path 60m. The mission mode driver circuit 116 is not part of ASIC 84 and only logically included in switching circuit 82. In one embodiment, the mission mode driver circuit 116 is part of the main circuit board that includes ASIC 84. In one embodiment, the mission mode driver circuit 116 is part of another circuit board, and not the main circuit board that includes ASIC 84. In one embodiment, the mission mode driver circuit 116 is a low bandwidth mission mode circuit.

ASIC 84 is put into debug mode or mission mode via a mode signal, where each of the multiplexers 100, 102, and 104 receive the mode signal. Also, switch 114 receives the mode signal. In one embodiment, mode circuit 86 receives a mode signal at one of the first I/O pins 46a-46n, which puts mode circuit 86 into either mission mode or debug mode based on the value of the mode signal. In other embodiments, ASIC 84 and mode circuit 86 are put into either mission mode or debug mode via multiple mode pin configurations or a programmable register.

In mission mode, first multiplexer 100, second multiplexer 102, and third multiplexer 104 provide outputs that correspond to signals received at their 1 inputs. Also, switch 114 is switched to transfer signals from the 1 side of switch 114 to first I/O pin 46n. Mission mode driver circuit 116 provides mission mode signals to first I/O pin 46n, which transfers the mission mode signals to the input of input circuit 106. The output of input circuit 106 provides signals corresponding to the mission mode signals to the 1 input of first multiplexer 100 and the output of first multiplexer 100 provides corresponding mission mode signals to the mission mode circuits 28. The 1 inputs of the second multiplexer 102 and the third multiplexer 104 are inactive.

In debug mode, first multiplexer 100, second multiplexer 102, and third multiplexer 104 provide outputs that correspond to the signals received at their 0 inputs. Also, switch 114 is switched to transfer signals between first I/O pin 46n and the 0 side of switch 114 coupled to debug cable line 76a. In debug mode, development mode signals are provided to the 0 side of switch 114 via debug equipment and debug cable line 76a. Switch 114 transfers the development mode signals to first I/O pin 46n and the input of input circuit 106. The output of input circuit 106 provides signals corresponding to the development mode signals to the 0 input of second multiplexer 102, which provides corresponding output signals to the development mode circuits 30 via development mode signal path 40a. The development mode circuits 30 provide development mode signals to the 0 input of third multiplexer 104 via development mode signal path 40b and the output of third multiplexer 104 provides corresponding development mode signals to the input of output circuit 108. Output circuit 108 provides output signals that correspond to the received development mode signals to first I/O pin 46n and switch 114, which transfers the signals to debug equipment via debug cable line 76a. Also, in debug mode, mission mode driver circuit 116 provides mission mode signals to probe circuit signal condenser 54 via probe circuit signal path 60m. Probe circuit signal condenser 54 serializes the received mission mode signals and other signals and provides a serial data stream to ASIC signal condenser 34 via communications path 26. ASIC signal condenser 34 de-serializes the serial data stream and provides the mission mode signals to the 0 input of first multiplexer 100 via second mission mode signal path 42a. First multiplexer 100 outputs corresponding mission mode signals to mission mode circuits 28 via first mission mode signal path 38a.

Thus, in mission mode first I/O pin 46n transfers mission mode signals and in debug mode first I/O pin 46n transfers development signals and second I/O pin 50 transfers mission mode signals.

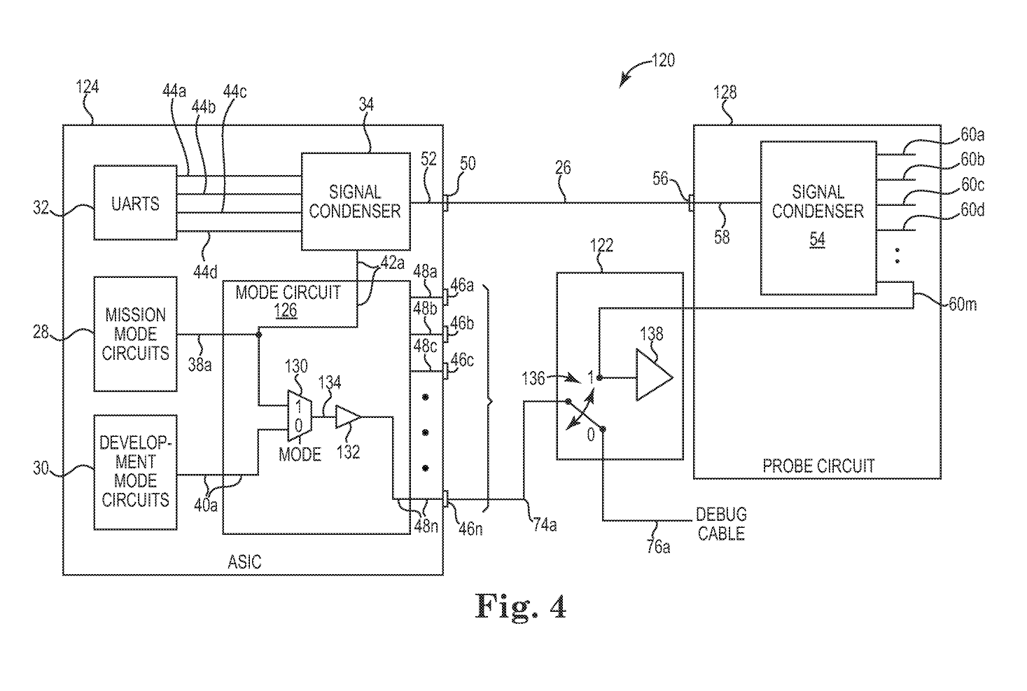

FIG. 4 is a diagram illustrating one embodiment of a system 120 that includes switching circuit 122 that receives a mission mode signal from ASIC 124 and mode circuit 126 that provides development mode signals to debug cable 76. UARTs 32 in ASIC 124 are development mode circuits. In other embodiments, ASIC 124 does not include the UARTs 32.

System 120 is similar to system 20 of FIG. 1. Also, ASIC 124 is similar to ASIC 22 (shown in FIG. 1) and probe circuit 128 is similar to probe circuit 24 (shown in FIG. 1).

Mode circuit 126 includes a multiplexer 130 and an output circuit 132. One of the mission mode circuits 28 is electrically coupled to ASIC signal condenser 34 and to the 1 input of multiplexer 130 via first and second mission mode signal paths 38a and 42a. The 0 input of multiplexer 130 is electrically coupled to one of the development circuits 30 via development mode signal path 40a. The output of multiplexer 130 is electrically coupled to the input of output circuit 132 via multiplexer output path 134 and the output of output circuit 132 is electrically coupled to first I/O pin 46n via I/O path 48n.

Switching circuit 122 includes a switch 136 and a mission mode receiver circuit 138 that receives mission mode signals. One side of switch 136 is electrically coupled to the output of output circuit 132 via switching path 74a, first I/O pin 46n, and I/O path 48n. The 0 side of switch 136 is electrically coupled to debug cable line 76a and the 1 side of switch 136 is electrically coupled to the input of mission mode receiver circuit 138 and to probe circuit signal condenser 54 via probe circuit signal path 60m. The mission mode receiver circuit 138 is not part of ASIC 124 and only logically included in switching circuit 122. In one embodiment, the mission mode receiver circuit 138 is part of the main circuit board that includes ASIC 124. In one embodiment, the mission mode receiver circuit 138 is part of another circuit board, and not the main circuit board that includes ASIC 124. In one embodiment, the mission mode receiver circuit 138 is a low bandwidth mission mode circuit.

ASIC 124 is put into debug mode or mission mode via a mode signal, where multiplexer 130 receives the mode signal. Also, switch 136 receives the mode signal. In one embodiment, mode circuit 126 receives a mode signal at one of the first I/O pins 46a-46n, which puts mode circuit 126 into either mission mode or debug mode based on the value of the mode signal. In other embodiments, ASIC 124 and mode circuit 126 are put into either mission mode or debug mode via multiple mode pin configurations or a programmable register.

In mission mode, multiplexer 130 provides output signals that correspond to mission mode signals received from the mission mode circuits 28 at the 1 input of multiplexer 130. Output circuit 132 receives the output signals from multiplexer 130 and provides signals corresponding to the mission mode signals to first I/O pin 46n. Switch 136 is switched to transfer signals from first I/O pin 46n to the 1 side of switch 136 and the input of mission mode receiver circuit 138.

In debug mode, multiplexer 130 provides output signals that correspond to development mode signals received from development mode circuits 30 at the 0 input of multiplexer 130. Output circuit 132 receives the output signals from multiplexer 130 and provides signals corresponding to the development mode signals to first I/O pin 46n. Switch 136 is switched to transfer signals from first I/O pin 46n to the 0 side of switch 136 and debug cable line 76a. Mission mode circuits 28 provide mission mode signals to ASIC signal condenser 34, which serializes the received mission mode signals and other signals and provides a serial data stream to probe circuit signal condenser 54 via communications path 26. Probe circuit signal condenser 54 de-serializes the serial data stream and provides the mission mode signals to the input of mission mode receiver circuit 138.

Thus, in mission mode first I/O pin 46n transfers mission mode signals and in debug mode first I/O pin 46n transfers development signals and second I/O pin 50 transfers mission mode signals.

The systems described herein use at least one I/O pin for transferring a mission mode signal in mission mode and the same I/O pin for transferring a development mode signal in debug mode, where at least one other I/O pin is used for transferring the mission mode signal in debug mode. By using the same I/O pin for mission mode signals in mission mode and development mode signals in debug mode the number of I/O pins on the ASIC can be reduced. Also, mission mode functionality is retained in debug mode by providing the mission mode signals via signal condensers.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system comprising:
an integrated circuit configured to transfer a mission mode signal between a mission mode circuit on the integrated circuit and a first input/output pin on the integrated circuit in mission mode and to transfer a development mode signal between a development mode circuit on the integrated circuit and the first input/output pin in debug mode, wherein the integrated circuit is configured to transfer the mission mode signal between the mission mode circuit and a second input/output pin on the integrated circuit in debug mode.

2. The system of claim 1, wherein the integrated circuit comprises:
a signal condenser configured to serialize/de-serialize multiple signals including the mission mode signal and to transfer the mission mode signal between the mission mode circuit and the second input/output pin in debug mode.

3. The system of claim 2, wherein the signal condenser is configured to serially transfer the mission mode signal via the second input/output pin in debug mode.

4. The system of claim 1, wherein the integrated circuit comprises:
at least one multiplexer configured to transfer the mission mode signal between the mission mode circuit and the first input/output pin in mission mode and to transfer the development mode signal between the development mode circuit and the first input/output pin in debug mode.

5. The system of claim 1, comprising:
a probe circuit configured to communicate with the integrated circuit via the second input/output pin and to transfer the mission mode signal through the second input/output pin in the debug mode.

6. The system of claim 5, wherein the integrated circuit comprises a first signal condenser configured to serialize/de-serialize multiple signals including the mission mode signal and the probe circuit comprises a second signal condenser configured to serialize/de-serialize the multiple signals including the mission mode signal, wherein the first signal condenser and the second signal condenser communicate via the second input/output pin.

7. The system of claim 6, wherein the first signal condenser and the second signal condenser serially transfer the mission mode signal via the second input/output pin in debug mode.

8. The system of claim 1, wherein the mission mode signal is a low bandwidth signal and the development mode signal is a high bandwidth signal.

9. The system of claim 1, comprising:
a switching circuit configured to transfer the mission mode signal between the first input/output pin and one of a driver and a receiver in mission mode and to transfer the development mode signal between the first input/output pin and a debug cable in debug mode.

10. A system comprising:
an integrated circuit configured to selectively dedicate a first input/output pin to transferring a mission mode signal in mission mode and to transferring a development mode signal in debug mode and configured to transfer the mission mode signal via a second input/output pin in debug mode.

11. The system of claim 10, comprising
a probe circuit configured to communicate with the integrated circuit via the second input/output pin, wherein the integrated circuit and the probe circuit are configured to transfer the mission mode signal via the second input/output pin in debug mode.

12. The system of claim 11, wherein the probe circuit comprises:
a mission mode circuit configured to perform at least part of a mission mode function in debug mode.

13. The system of claim 11, wherein the integrated circuit comprises a first signal condenser and the probe circuit comprises a second signal condenser, wherein the first signal condenser and the second signal condenser communicate via the second input/output pin.

14. The system of claim 13, wherein the first signal condenser is configured to serialize/de-serialize multiple signals including the mission mode signal and the second signal condenser is configured to serialize/de-serialize the multiple signals including the mission mode signal and the first signal condenser and the second signal condenser serially transfer the mission mode signal via the second input/output pin in debug mode.

15. The system of claim 10, wherein the mission mode signal is a low bandwidth signal and the development mode signal is a high bandwidth signal.

16. A method comprising:
selecting one of a mission mode and a debug mode;
transferring a mission mode signal between a mission mode circuit on an integrated circuit and a first input/output pin on the integrated circuit in the mission mode;
transferring a development mode signal between a development mode circuit on the integrated circuit and the first input/output pin in the debug mode; and
transferring the mission mode signal between the mission mode circuit and a second input/output pin on the integrated circuit in the debug mode.

17. The method of claim 16, wherein transferring the mission mode signal between the mission mode circuit and a second input/output pin on the integrated circuit in the debug mode comprises:
serializing/de-serializing signals including the mission mode signal in the debug mode; and
transferring the mission mode signal serially via the second input/output pin in the debug mode.

18. The method of claim 16, comprising:
selecting a first input on at least one multiplexer to transfer the mission mode signal between the mission mode circuit and the first input/output pin in the mission mode; and
selecting a second input on the at least one multiplexer to transfer the development mode signal between the development mode circuit and the first input/output pin in the debug mode.

19. The method of claim 16, comprising:
transferring the mission mode signal between the integrated circuit and a probe circuit via the second input/output pin in the debug mode.

20. The method of claim 19, comprising:
serializing/de-serializing signals including the mission mode signal via a first signal condenser on the integrated circuit;
serializing/de-serializing signals including the mission mode signal via a second signal condenser on the probe circuit; and
transferring the mission mode signal serially via the first signal condenser and the second signal condenser and the second input/output pin in the debug mode.
